(19) United States
(12) Patent Application Publication
(10) Pub. No.: US 2026/0020098 A1
(43) Pub. Date: Jan. 15, 2026

(54) METHOD FOR AN ACCESS NETWORK NODE, METHOD FOR A CORE NETWORK NODE, METHOD FOR A USER EQUIPMENT, AN ACCESS NETWORK NODE, A CORE NETWORK NODE, AND A USER EQUIPMENT

(71) Applicant: NEC CORPORATION, Minato-ku, Tokyo (JP)

(72) Inventor: Zhe CHEN, Guildford (GB)

(73) Assignee: NEC CORPORATION, Minato-ku, Tokyo (JP)

(21) Appl. No.: 18/881,818

(22) PCT Filed: Aug. 1, 2023
(86) PCT No.: PCT/JP2023/028181

§ 371 Date: Jan. 7, 2025

(30) Foreign Application Priority Data
Aug. 9, 2022 (GB) 2211642.0

(51) Int. Cl. H04W 76/27; H04W 4/06; H04W 76/11

(52) U.S. Cl. CPC H04W 76/27; H04W 4/06; H04W 76/11

(57) ABSTRACT

A method for an access network node is provided. The method comprises transmitting, to a user equipment, UE, a first message including an enquiry of a capability of the UE to receive a multicast/broadcast service, MBS, in a case where the UE is in a Radio Resource Control, RRC,_INACTIVE state; and receiving from the UE, a second message including a list of one or more MBS sessions which the UE can support in a case where the UE is in the RRC_INACTIVE state, in a case where the UE has information identifying at least one MBS that is available to the UE.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to improvements relating to session management of multimedia broadcast sessions operating according to the so-called ‘5G’ (or ‘Next Generation’) systems or similar.

### BACKGROUND ART

The latest developments of the 3GPP standards are referred to as ‘5G’ or ‘New Radio’ (NR). These terms refer to an evolving communication technology that supports a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network (NGC).

Under the 3GPP standards, the base station (e.g. an ‘eNB’ in 4G or a ‘gNB’ in 5G) is a node via which communication devices (user equipment or ‘UE’) connect to a core network and communicate to other communication devices or remote servers. For simplicity, the present application will use the term base station or access network node to refer to any such base stations. For simplicity, the present application will use the term mobile device, user device, or UE to refer to any communication device that is able to connect to the core network via one or more base stations.

Communication devices might be, for example, mobile communication devices such as mobile telephones, smartphones, user equipment, personal digital assistants, laptop/tablet computers, web browsers, e-book readers and/or the like. Such mobile (or even generally stationary) devices are typically operated by a user. However, 3GPP standards also make it possible to connect so-called ‘Internet of Things’ (IoT) devices (e.g. Narrow-Band IoT (NB-IoT) devices) to the network, which typically comprise automated equipment, such as various measuring equipment, telemetry equipment, monitoring systems, tracking and tracing devices, in-vehicle safety systems, vehicle maintenance systems, road sensors, digital billboards, point of sale (POS) terminals, remote control systems, and the like. Effectively, the Internet of Things is a network of devices (or “things”) equipped with appropriate electronics, software, sensors, network connectivity, and/or the like, which enables these devices to collect and exchange data with each other and with other communication devices. It will be appreciated that IoT devices are sometimes also referred to as Machine-Type Communication (MTC) communication devices or Machine-to-Machine (M2M) communication devices.

For simplicity, the present application often refers to mobile devices in the description but it will be appreciated that the technology described can be implemented on any communication devices (mobile and/or generally stationary) that can connect to a communications network for sending/receiving data, regardless of whether such communication devices are controlled by human input or software instructions stored in memory.

One of the recent features being developed over the existing 5G framework is referred to as Multicast and Broadcast Services (MBS). This functionality aims to enhance 5G New Radio and 5G Core Network capabilities for a reliable, low latency, resource efficient, and massive deployment of a wide array of multicast and broadcast services. 3GPP is currently specifying the details of MBS for media distribution over mobile broadband networks. Some of the use cases identified that could benefit from MBS include public safety and mission critical services, vehicle to everything (V2X) applications, IPTV, live video, software delivery, and IoT applications to a variety of smartphones, tablets, vehicles, and other mobile (or stationary) devices. Although MBS is designed to use existing (or already specified) 3GPP infrastructure, it can provide a more efficient delivery of multicast/broadcast traffic than unicast communication using the same infrastructure. Details of architectural enhancements for MBS may be found in the in 3GPP Technical Specification (TS) 23.247 V17.2.0.

To facilitate resource-efficient delivery of multicast/broadcast services, 3GPP have developed NR broadcast/multicast as part of release 17 (Rel-17) of the NR standards, with the aim of enabling general MBS services over a 5G telecommunications network. In more detail, two delivery modes for MBS were agreed for Rel-17 MBS:
delivery mode 1 (only for multicast) capable of addressing higher QoS services; and
delivery mode 2 (only for broadcast) focusing on lower QoS services.

Rel-17 MBS provides the basic functionality to support MBS services, but it has been acknowledged that resource efficiency and capacity needs to be improved, as well as other issues addressed, to meet the stringent use cases proposed for MBS.

For instance, according to Rel-17, the radio access network (RAN) only specifies multicast transmissions for UEs which are in RRC Connected state (sometimes referred to as RRC_CONNECTED mode) and hence UEs which are in the other RRC connection states, i.e. in the RRC Inactive state and in the RRC Idle state (sometimes referred to as RRC_INACTIVE mode and RRC_IDLE mode respectively), do not receive such transmissions—this situation may not fully meet the requirements of, for example, mission critical services, especially in the circumstances of cells serving many UEs (e.g. according to TR 23.774). Moreover, always keeping UEs in the RRC Connected state is not efficient (e.g. with respect to resource usage, power, etc.) from the perspective of the base station nor from the perspective of the UE.

The disclosers have realised that there are a number of issues with the current approach to the provision of MBS functionality, especially in the context of UE RRC connection state transitions and UE mobility. Accordingly, the present disclosure seeks to provide methods and associated apparatus that address or at least alleviate (at least some of) the above-described issues.

### CITATION LIST

### Patent Literature

PTL 1: WO2022/086121A1
PTL 2: WO2022/239690A1

### Non Patent Literature

NPL 1: 3GPP TS 23.247
NPL 2: 3GPP TS 23.003
NPL 3: 3GPP TS 23.003
NPL 4: 3GPP TS 24.116
NPL 5: 3GPP TR 23.774
NPL 6: 3GPP TS 38.413
NPL 7: 3GPP TS 38.473
NPL 8: 3GPP TS 38.401
NPL 9: 3GPP TS 38.300
NPL 10: 3GPP TS 37.340

### SUMMARY OF INVENTION

### Technical Problem

The disclosure aims to provide apparatus and related methods aimed at contributing, at least partially, to meeting one or more of the above needs.

### Solution to Problem

According to one aspect, there is provided a method for an access network node, the method comprising:
transmitting, to a user equipment, UE, in a Radio Resource Control, RRC,_INACTIVE state, a first message indicating a capability of the UE to receive a multicast/broadcast service, MBS; and receiving from the UE, a second message indicating one or more MBS sessions which the UE in the RRC_INACTIVE state can support in a case where the UE has information identifying at least one MBS that is available to the UE, wherein
at least one MBS corresponding to the one or more MBS sessions is provided to the UE while the UE in the RRC_INACTIVE state.

According to another aspect, there is provided a method for an access network node having a central unit and a distributed unit, the method comprising:
receiving, by the central unit, from a core network node, an indication of at least one multicast/broadcast service, MBS, session which a user equipment, UE, in a Radio Resource Control, RRC,_INACTIVE state can access;
transmitting, by the central unit, the indication to the distributed unit;
receiving, by the central unit, a response from the distributed unit; and
transmitting, by the distributed unit, the indication to the UE.

According to another aspect, there is provided a method for a first access network node, the method comprising:
transmitting, to a user equipment, UE, being served by the first access network node, information that includes an ongoing multicast/broadcast service, MBS, session list of a second access network node neighbouring the first access network node or a neighbour cell/frequency list of at least one neighbouring access network node that has at least one on-going MBS session.

According to another aspect, there is provided a method performed by a source access network node for handover of a user equipment, UE, to a target access network node, the method comprising:
transmitting, to the target access network node, a conditional handover request message including multicast/broadcast service, MBS, configuration information for the UE.

According to another aspect, there is provided a method performed by a target access network node for handover of a user equipment, UE, from a source access network node, the method comprising:
receiving, from the source access network node, a conditional handover request message including multicast/broadcast service, MBS, configuration information for the UE;
in a case where there is no on-going MBS session in the target access network node, establishing an MBS session with a core network.

According to another aspect, there is provided a method for a core network node, the method comprising:
transmitting, to a further core network node, a message including an indication of one or more multicast/broadcast service, MBS, sessions which a user equipment, UE, in a Radio Resource Control, RRC,_INACTIVE state can access.

According to another aspect, there is provided a method for a core network node, the method comprising:
transmitting, to an access network node, a message including an indication of one or more multicast/broadcast service, MBS, sessions which a user equipment, UE, in a Radio Resource Control, RRC,_INACTIVE state can access.

According to another aspect, there is provided a method for a user equipment, UE, the method comprising:
receiving, from an access network node, a first message indicating a capability of the UE in a Radio Resource Control, RRC,_INACTIVE state to receive a multicast/broadcast service, MBS;
transmitting, to the access network node, a second message indicating one or more MBS sessions which the UE in the RRC_INACTIVE state can support, based on information identifying at least one MBS that is available to the UE; and
receiving at least one MBS corresponding to the one or more MBS sessions while the UE in the RRC_INACTIVE state.

According to another aspect, there is provided a method for a user equipment, UE, the method comprising:
receiving, from a distributed unit of an access network node, an indication of one or more multicast/broadcast service, MBS, sessions which the UE in a Radio Resource Control, RRC,_INACTIVE state can access.

According to another aspect, there is provided a method for a user equipment, UE, the method comprising:
receiving, from a first access network node, information that includes an ongoing multicast/broadcast service, MBS, session list of a second access network node neighbouring the first access network node, or a neighbour cell/frequency list of at least one neighbouring access network node that has at least one on-going MBS session.

According to another aspect, there is provided an access network node comprising:
means for transmitting, to a user equipment, UE, in a Radio Resource Control, RRC,_INACTIVE state, a first message indicating a capability of the UE to receive a multicast/broadcast service, MBS; and
means for receiving from the UE, a second message indicating one or more MBS sessions which the UE in the RRC_INACTIVE state can support in a case where the UE has information identifying at least one MBS that is available to the UE, wherein
at least one MBS corresponding to the one or more MBS sessions is provided to the UE while the UE in the RRC_INACTIVE state.

According to another aspect, there is provided an access network node having a central unit and a distributed unit, wherein
the central unit comprises:
means for receiving, from a core network node, an indication of at least one multicast/broadcast service, MBS, session which a user equipment, UE, in a Radio Resource Control, RRC,_INACTIVE state can access;
   means for transmitting the indication to the distributed unit; and
   means for receiving a response from the distributed unit; and
the distributed unit comprises:
means for transmitting the indication to the UE.

According to another aspect, there is provided a first access network node comprising:
means for transmitting, to a user equipment, UE, being served by the first access network node information that includes an ongoing multicast/broadcast service, MBS, session list of a second access network node neighbouring the first access network node or a neighbour cell/frequency list of at least one neighbouring access network node that has at least one on-going MBS session.

According to another aspect, there is provided a source access network node for handover of a user equipment, UE, to a target access network node, the source access network node comprising:
means for transmitting, to the target access network node, a conditional handover request message including multicast/broadcast service, MBS, configuration information for the UE.

According to another aspect, there is provided a target access network node for handover of a user equipment, UE, from a source access network node, the target access network node comprising:
means for receiving, from the source access network node, a conditional handover request message including multicast/broadcast service, MBS, configuration information for the UE;
means for establishing an MBS session with a core network in a case where there is no on-going MBS session in the target access network node.

According to another aspect, there is provided a core network node comprising:
means for transmitting, to a further core network node, a message including an indication of one or more multicast/broadcast service, MBS, sessions which a user equipment, UE, in a Radio Resource Control, RRC,_INACTIVE state can access.

According to another aspect, there is provided a core network node comprising:
means for transmitting, to an access network node, a message including an indication of one or more multicast/broadcast service, MBS, sessions which a user equipment, UE, in a Radio Resource Control, RRC,_INACTIVE state can access.

According to another aspect, there is provided a user equipment, UE, comprising:
means for receiving, from an access network node, a first message indicating a capability of the UE in a Radio Resource Control, RRC,_INACTIVE state to receive a multicast/broadcast service, MBS;
means for transmitting, to the access network node, a second message indicating one or more MBS sessions which the UE in the RRC_INACTIVE state can support, based on information identifying at least one MBS that is available to the UE; and
receiving at least one MBS corresponding to the one or more MBS sessions while the UE in the RRC_INACTIVE state.

According to another aspect, there is provided a user equipment, UE, comprising:
means for receiving, from a distributed unit of an access network node, an indication of one or more multicast/broadcast service, MBS, sessions which the UE in a Radio Resource Control, RRC,_INACTIVE state can access.

According to another aspect, there is provided a user equipment, UE, comprising:
means for receiving, from a first access network node, information that includes an ongoing multicast/broadcast service, MBS, session list of a second access network node neighbouring the first access network node, or a neighbour cell/frequency list of at least one neighbouring access network node that has at least one on-going MBS session.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### Advantageous Effects of Invention

According to the present disclosure, it is possible to provide a method of a user equipment, a method of an access network node, the user equipment, and the access network node.

### BRIEF DESCRIPTION OF DRAWINGS

Example embodiments of the disclosure will now be described, by way of example, with reference to the accompanying drawings in which:

FIG. 1 schematically illustrate a mobile (cellular or wireless) telecommunication system to which example embodiments of the disclosure may be applied;

FIG. 2 schematically illustrate a mobile (cellular or wireless) telecommunication system to which example embodiments of the disclosure may be applied;

FIG. 3 is a schematic block diagram of a mobile device forming part of the system shown in FIGS. 1 and 2;

FIG. 4 is schematic block diagrams of an access network node (e.g. base station) forming part of the system shown in FIGS. 1 and 2;

FIG. 5 is schematic block diagrams of an access network node (e.g. base station) forming part of the system shown in FIGS. 1 and 2;

FIG. 6 is a schematic block diagram of a core network node forming part of the system shown in FIGS. 1 and 2;

FIG. 7 illustrates schematically some exemplary ways in which the present disclosure may be implemented in the system shown in FIGS. 1 and 2;

FIG. 8 illustrates schematically some exemplary ways in which the present disclosure may be implemented in the system shown in FIGS. 1 and 2;

FIG. 9 illustrates schematically some exemplary ways in which the present disclosure may be implemented in the system shown in FIGS. 1 and 2; and

FIG. 10 illustrates schematically some exemplary ways in which the present disclosure may be implemented in the system shown in FIGS. 1 and 2.

### DESCRIPTION OF EXAMPLE EMBODIMENTS

### <Overview >

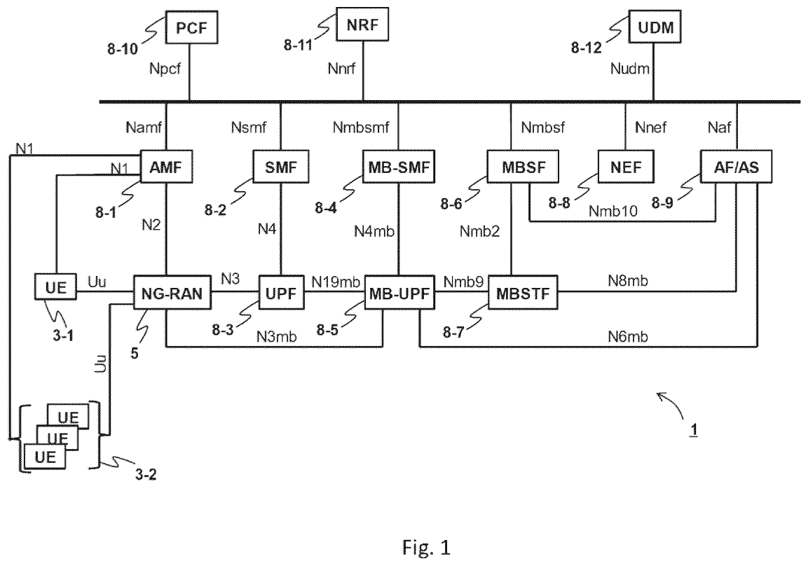

FIG. 1 illustrates schematically a mobile (cellular or wireless) telecommunication system 1 to which example embodiments of the disclosure may be applied.

In system 1, users of mobile devices 3 (UEs) can communicate with each other and other users via base stations 5 and other access network nodes which form the radio access network (RAN), via which UEs communicate with an associated core network 7 using an appropriate 3GPP radio access technology (RAT), for example, an Evolved Universal Terrestrial Radio Access (E-UTRA) and/or 5G RAT. It will be appreciated that a number of base stations 5 form a (radio) access network or (R) AN. As those skilled in the art will appreciate, whilst four mobile devices 3 and one base station (encompassed by NG-RAN 5 in FIG. 1) are shown in FIG. 1 for illustration purposes, the system, when implemented, will typically include other base stations/(R) AN nodes and/or mobile devices (UEs).

Each base station 5 controls one or more associated cells (either directly or via other nodes such as home base stations, relays, remote radio heads, distributed units, and/or the like). A base station 5 that supports Next Generation/5G protocols may be referred to as ‘gNBs’, and form part of the NG-RAN. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 are connected to each other via an appropriate base station to base station interface (such as the so-called ‘Xn’ interface, the ‘X2’ interface, and/or the like, not shown in FIG. 1). Base stations 5 are also connected to the core network nodes via appropriate interfaces (such as the so-called ‘NG-U’ interface (for user-plane), the so-called ‘NG-C’ interface (for control-plane), and/or the like).

A core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) and one or more user plane functions (UPFs) 8-3. An example of a CPF is the so-called Access and Mobility Management Function (AMF) 8-1 in 5G, or the Mobility Management Entity (MME) in 4G, which is responsible for handling connection and mobility management tasks for the mobile devices 3. Another example CPF is the so-called Session Management Function (SMF) 8-2 which is responsible for handling communication sessions for the mobile devices 3 such as session establishment, modification, and release.

The core network 7 may further include an Multicast/Broadcast Session Management Function (MB-SMF) 8-4, Multicast/Broadcast User Plane Function (MB-UPF) 8-5, Multicast/Broadcast Service Function (MBSF) 8-6, Multicast/Broadcast Service Transport Function (MBSTF) 8-7, Network Exposure Function (NEF) 8-8, Application Function (AF) 8-9, Policy Control Function (PCF) 8-10, Network Repository Function (NRF) 8-11, and a Unified Data Management (UDM) entity 8-12, in addition to other nodes/functions not described here. Several service-based interfaces are illustrated in FIG. 1, namely:
Nmbsmf: Service-based interface exhibited by MB-SMF.
Npcf: Service-based interface exhibited by PCF.
Namf: Service-based interface exhibited by AMF.
Nnef: Service-based interface exhibited by NEF.
Nnrf: Service-based interface exhibited by NRF.
Nudm: Service-based interface exhibited by UDM.

Moreover, several reference points are illustrated in FIG. 1, namely:
N2: Reference point between the NG-RAN and the AMF.
N3: Reference point between the NG-RAN and the UPF.
N3 mb: Reference point between the RAN and the MB-UPF.
N4mb: Reference point between the MB-SMF and the MB-UPF.
N6mb: Reference point between the MB-UPF and the AF/AS.
N19mb: Reference Point between the UPF and the MB-UPF.
Nmb1: Reference point between the MB-SMF and the MBSF.
Nmb2: Reference point between the MBSF and the MBSTF.
Nmb9: Reference point between the MB-UPF and the MBSTF.
Nmb10: Reference point between the MBSF and the AF.

The core network 7 is coupled (via the UPF 8-3) to a Data Network (not shown), such as the Internet or a similar Internet Protocol (IP) based network.

Various network operators deploy their base stations 5 and an associated core network 7 to provide services in a given area (e.g. a country). Each network may also be referred to as a Public Land Mobile Network (PLMN) and it is uniquely identified by its PLMN identifier (PLMN ID). The PLMN ID consists of a Mobile Country Code (MCC) and a Mobile Network Code (MNC). Each subscriber (i.e. UE 3) belongs to the PLMNs and uses services of the associated core network 7 and access network (i.e. base stations 5).

Multicast and Broadcast Services (MBS) functionality, which e.g. provides resource efficient transmission to multiple end users which require receipt of the same service, may be provided to the UEs 3 via their serving base station 5 and associated core network nodes such as the UPF 8-3 and the SMF 8-2. The UPF 8-3 may be an MBS specific UPF in which case it may be referred to as the MB-UPF 8-5 (e.g. dedicated to the provision of MBS functionality). Similarly, the SMF 8-2 may be an MBS specific SMF in which case it may be referred to as the MB-SMF 8-4. However, it will be appreciated that any suitable UPF/SMF may be used for MBS.

Each UE 3 interested in MBS monitors the system information broadcast by the base stations 5 and determines the resources used for the relevant control channel and data channel (MCCH and MTCH, respectively). The base stations 5 also broadcast the respective identifiers (MBS Session IDs or Temporary Mobile Group Identities, TMGIs) for each MBS session provided in their cell. If the UE 3 finds its own PLMN ID in the system information for a given cell, then it is allowed to access the cell.

The TMGI is the MBS session identifier that uniquely identifies a particular MBS Service. The TMGI has three parts: an MBMS Service ID part; a Mobile Country Code (MCC) part; and a Mobile Network Code (MNC) part. 3GPP TS 38.413, clause 9.3.1 defines the three parts of the TMGI as follows:
1) MBMS Service ID consisting of three octets. MBMS Service ID consists of a 6-digit fixed-length hexadecimal number between 000000 and FFFFFF. MBMS Service ID uniquely identifies an MBMS bearer service within a PLMN. The structure of MBMS Service ID for services for Receive only mode is defined in 3GPP TS 24.116;
2) Mobile Country Code (MCC) consisting of three digits. The MCC identifies uniquely the country of domicile of the Broadcast-Multicast Service Centre (BM-SC), except for the MCC value of 901, which does not identify any country and is assigned globally by the International Telecommunication Union (ITU); and
3) Mobile Network Code (MNC) consisting of two or three digits (depending on the assignment to the PLMN by its national numbering plan administrator). The MNC identifies the PLMN which the BM-SC belongs to, except for the MNC value of 56 when the MCC value is 901, which does not identify any PLMN. For more information on the use of the TMGI, see 3GPP TS 23.246.

3GPP TS 23.003 defines the parts of the PLMN ID as follows:
1) Mobile Country Code (MCC) consisting of three digits. The MCC identifies uniquely the country of domicile of the mobile subscription; and
2) Mobile Network Code (MNC), consisting of two or three digits for 3GPP network applications (depending on the assignment to the PLMN by its national numbering plan administrator). The MNC identifies the home PLMN of the mobile subscription within its country of domicile, or it identifies together with MCC and Network Identifier (NID) the mobile subscription's Stand-alone Non-Public Network (SNPN). The length of the MNC (two or three digits) depends on the value of the MCC.

The list of PLMNs supported in a cell is indicated in the relevant system information. Specifically, system information block type 1 (SIB1) includes the list of supported PLMNs in the plmn-IdentityInfoList information element (which is included in the so-called CellAccessRelatedInfo information element of SIB1).

The MBS session establishment procedure has been standardised by 3GPP in TS 23.247. Specifically, clause 7.2.1.3 defines the current procedure for joining a multicast session and the associated session establishment procedure. Additionally, multicast session management procedures are defined in 3GPP TS 38.413 (per clause 8.18). The content of these documents is hereby incorporated by reference.

As shown in FIG. 1, there is a single UE 3-1 having a connection with the NG-RAN 5, and a group of three UEs also having respective connections with the NG-RAN 5. UE 3-1 receives data for its MBS session in a point-to-point (PTP) manner, whereas the group of UEs 3-2 receive data for their MBS sessions in a point-to-multipoint (PTM) manner.

However, and as mentioned above, several issues with the current MBS session management procedures need to be addressed, not least that the above procedure only currently applies to UEs in the RRC Connected state.

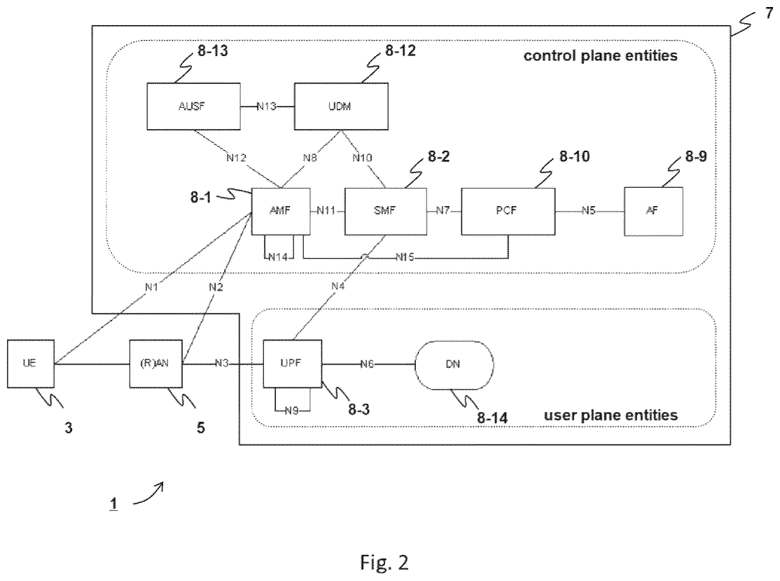

FIG. 2 illustrates further details of the core network 7, which also shows the interfaces between respective network nodes. As can be seen, the core network 7 may typically include an Authentication Server Function (AUSF), a Unified Data Management (UDM) entity, a Policy Control Function (PCF), an Application Function (AF), amongst others (e.g. as set above with respect to FIG. 1). The core network 7 is coupled (via the UPF) to a Data Network (DN) 8-14, such as the Internet or a similar Internet Protocol (IP) based network. The core network 7 may also be coupled to an Operations and Maintenance (OAM) function (not shown).

In the following, solutions to the problems of current MBS session provision and management will be outlined. Firstly, however, a discussion of several nodes forming part of system 1 will be described.

### <User Equipment (UE)>

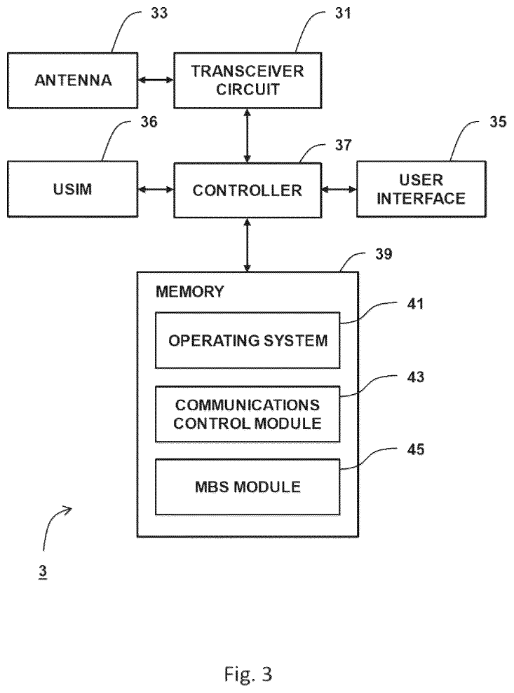

FIG. 3 is a block diagram illustrating the main components of the mobile device (UE) 3 shown in FIGS. 1 and 2. As shown, the UE 3 includes a transceiver circuit 31 which is operable to transmit signals to and to receive signals from one or more connected nodes via one or more antenna 33. Although not necessarily shown in FIG. 3, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43 and an MBS module 45.

The communications control module 43 is responsible for handling (generating/sending/receiving) signalling messages and uplink/downlink data packets between the UE 3 and other nodes, including (R) AN nodes 5 and core network nodes. The signalling may comprise RRC signalling (to/from the (R) AN nodes 5) and/or NG-C/NG-U signalling (to/from the core network 7 (via the RAN)).

The MBS module 45 is responsible for handling signalling relating to multimedia broadcast services.

### <Access Network Node (Base Station)>

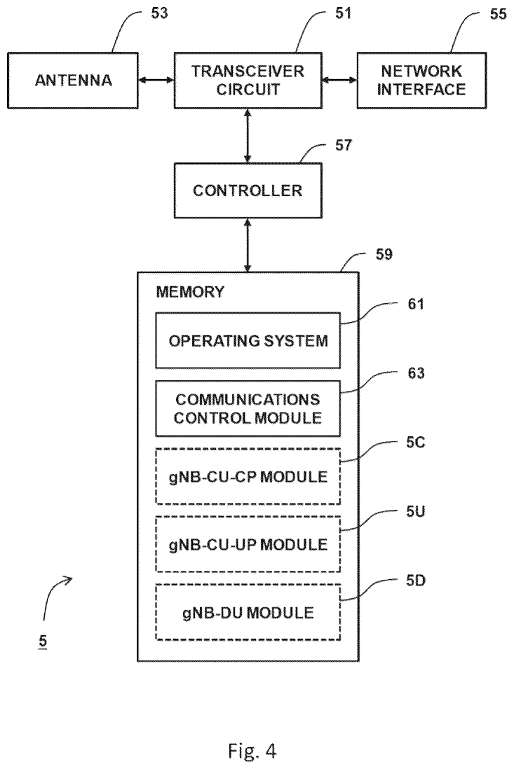

FIG. 4 is a block diagram illustrating the main components of a base station 5 (or a similar access network node) shown in FIG. 1. As shown, the base station 5 has a transceiver circuit 51 for transmitting signals to and for receiving signals from user equipment (such as the mobile device 3) via one or more antenna 53, a network interface 55 for transmitting signals to and for receiving signals from the core network 7 and neighbouring base stations. The base station 5 has a controller 57 to control the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, and at least a communications control module 63. Although not shown in FIG. 4, the network interface 55 will also typically include a base station to base station interface portion (e.g. Xn and/or the like), and a core network interface portion (e.g. NG-C/NG-U/N2/N3).

The communications control module 63 is responsible for handling (generating/sending/receiving) signalling between the base station 5 and other nodes, such as the UE 3 and the core network nodes. Such signalling may include, for example, control data for managing operation of the mobile device 3 (e.g. Non-Access Stratum, Radio Resource Control, system information, paging, and/or the like). The signalling may include signalling for configuring the UE 3 for receiving an MBS session and signalling for configuring other nodes for providing the MBS session. It will be appreciated that the communications control module 63 may include a number of sub-modules (or ‘layers’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

In the 5G architecture, the base station (gNB or en-gNB) internal structure may be split into two parts known as the Central Unit (CU) and the Distributed Unit (DU), connected by an F1 interface. In this ‘split’ architecture, typically ‘higher’, CU layers (for example, but not necessarily or exclusively), PDCP and the typically ‘lower’, DU layers (for example, but not necessarily or exclusively, RLC/MAC/PHY) may be implemented separately. Thus, for example, the higher layer CU functionality for a number of gNBs may be implemented centrally (for example, by a single processing unit, or in a cloud-based or virtualised system), whilst retaining the lower layer DU functionality locally, in each of the gNB.

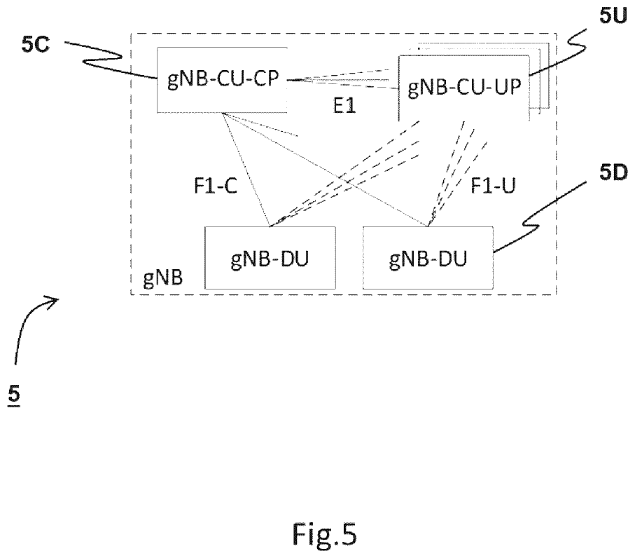

As shown in FIG. 5, when the base station 5 comprises a distributed base station (gNB or en-gNB), the network interface 55 also includes an E1 interface and an F1 interface (F1-C for control plane and F1-U for user plane) to communicate signals between respective functions of the distributed base station. In this case, the software stored in the base station 5 also includes at least one of: a gNB-CU-CP module 5C, a gNB-CU-UP module 5U, and a gNB-DU module 5D. If present, the gNB-CU-CP module 5C hosts the RRC layer and the control plane part of the PDCP layer of the distributed base station (gNB or en-gNB). If present, the gNB-CU-UP module 5U hosts the user plane part of the PDCP and the SDAP layers of the distributed gNB or the user plane part of the PDCP layer of the distributed en-gNB. If present, the gNB-DU module 5D hosts the RLC, MAC, and PHY layers of the distributed base station (gNB or en-gNB).

It will be understood by a person skilled in the art that the central unit (e.g. 5C and/or 5U) may be implemented and physically located with the base station or may be implemented at a remote location, as a single physical element or as a cloud-based or virtualised system. It will also be understood that a single central unit may serve multiple base stations 5.

### <Core Network Node >

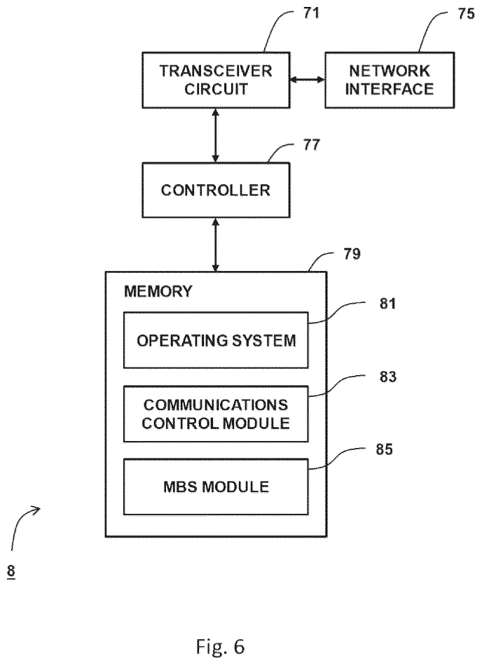

FIG. 6 is a block diagram illustrating the main components of a core network node shown in FIGS. 1 and 2 (e.g. the AMF 8-1, the SMF 8-2, the UPF 8-3, etc.). As shown, the core network node includes a transceiver circuit 71 which is operable to transmit signals to and to receive signals from other network nodes (either directly or indirectly) via a network interface 75. Signals may be transmitted to and received from one or more UEs 3 via the base station 5 or other (R) AN nodes, as appropriate. The network interface 75 typically includes an appropriate base station interface (such as S1/NG-C/NG-U). A controller 77 controls the operation of the core network node in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and an optional MBS module 85.

The communications control module 83 is responsible for handling (generating/sending/receiving) signalling between the core network node and other nodes, such as the UE 3, (R) AN nodes, and other core network nodes.

If present, e.g. in an MB-SMF 8-4 or MB-UPF 8-6, the MBS module 85 is responsible for handling signalling relating to multimedia broadcast services (control signalling and/or MBS traffic). The signalling may comprise signalling relating to the provision of MBS sessions via a RAN/base station, and signalling for configuring other nodes for providing the MBS session via the RAN/base station.

### <Detailed Description >

As noted above, there are several issues with MBS session management. The following detailed description sets out several solutions to these issues.

### 1. RRC_INACTIVE Mode Configuration

According to Rel-17 MBS, when an MBS session is activated, RAN node 5 sends a paging message which includes a TMGI list which identifies the different MBS sessions that are available via the RAN node 5. If a UE 3 is interested in the MBS session which has a TMGI on the list, then the current standards specify that the UE 3 should transition to the RRC_CONNECTED mode in order to be able to receive the MBS transmission. However, UEs operating in accordance with the latest version of the 3GPP NR standards (Release 18) may be in one of three potential RRC modes (connection states) with their serving base station:
1) RRC_CONNECTED;
2) RRC_INACTIVE; or
3) RRC_IDLE.

The state RRC_INACTIVE is a state that allows the UE to resume quickly to the RRC CONNECTED state and it is proposed that the UE should be able to receive MBS transmissions whilst in the RRC_INACTIVE state (albeit without the normally high reliability of service guaranteed by being in the RRC CONNECTED state and provided the MBS service allows). Accordingly, provided a UE 3 is capable to transition to the RRC_INACTIVE mode, then that UE does not need to transition to RRC_CONNECTED mode if the MBS service allows UEs access to the MBS service when in the RRC_INACTIVE mode. It is mutually beneficial to the network and to the UE for a UE not to transition to/remain in RRC_CONNECTED mode, if it can be avoided, as resources can be saved on both the network and the UE side.

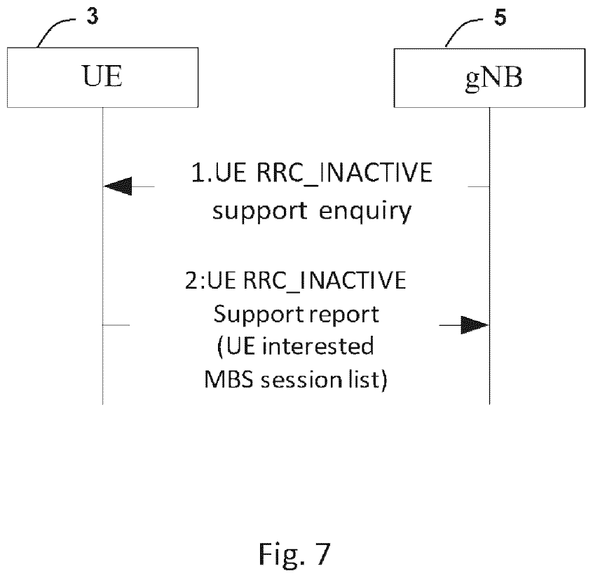

In this regard, FIG. 7 illustrates a procedure between a UE 3 and a RAN node (such as a gNB) of the telecommunications system 1, by which the network determines the UE 3's capability to support an RRC_INACTIVE mode configuration in the context of an MBS session. In step 1, the RAN node 5 sends an enquiry to determine the UE's capability of reception of MBS in RRC_INACTIVE mode. This enquiry (which may be referred to as a UE RRC_INACTIVE support enquiry) can be sent in a dedicated RRC message (e.g., UEcapablityenquiry, RRCSetupComplete, or another appropriate message), in a paging message, in a system information block (SIB) or in signalling over a multicast control channel (such as an MBMS Control Channel (MCCH), MBS Control Channel (MCCH), or the like).

In step 2, the UE 3 reports whether or not it can support the RRC_INACTIVE state. This response may be referred to as a UE RRC_INACTIVE support report and can also include a list of MBS sessions that the UE is interested in receiving. On receipt of this information, the network can beneficially configure RRC_INACTIVE mode support for the UE, and manage the relevant MBS sessions for the UE in view of the received report.

Changes to the current procedures are required to inform the UE 3 when it is not necessary for it to transition to the RRC_CONNECTED state in order to receive the MBS transmission.

A first option associates each TMGI in the TMGI list broadcast by RAN node with an indication. If the indication is set to e.g. “yes”, then UEs operating in accordance with the latest version of the standards (i.e. Release 18 (Rel-18) UEs) transition to RRC_CONNECTED mode if the UE wishes to receive that MBS transmission, whereas if the indication is set to e.g. “no”, then the UE will not transition to RRC CONNECTED mode if the UE wishes to receive that MBS transmission. The structure of the modified paging message may take the following format:
Paging::=SEQUENCE
Paging-v1700-IEs::={SEQUENCE
pagingRecordList-v1700 pagingRecordList-v1700
OPTIONAL, --Need N
pagingRecordList-v1700 pagingRecordList-v1700
OPTIONAL,
}
PagingGroupList-r18::=SEQUENCE
(SIZE(1 . . . maxNrofPageGroup-r18)) OF MBSService
MBSService::=SEQUENCE {
TMGI
RRCCONNECTEDINDICATION-R18
}

Thus in this case, this indication indicates whether or not the corresponding MBS service allows the UE to receive the MBS service in the RRC_INACTIVE state and so UEs that are capable of operating in the RRC_INACTIVE state can decide whether or not they need to transition to the RRC_CONNECTED state based on one or more indications for one or more MBS services that they wish to receive.

According to an alternative option, the UE may instead be configured not to transition into the RRC_CONNECTED mode even if the paging message includes a TMGI that UE is interested in.

### 2. RRC States Transition

MBS-capable UEs may transition from the RRC_CONNECTED state to the RRC_INACTIVE state in order to, for example, save power and enhance the capacity of the serving cell (by minimising the signalling overhead associated with keeping UEs in the RRC_CONNECTED state).

Similarly, MBS-capable UEs may transition from the RRC_INACTIVE state to the RRC CONNECTED state in the case where a UE moves to the edge of the serving cell and the network establishes another point-to-point (PTP) leg of the MBS radio bearer (MRB) to enhance the reliability of the MBS service the UE receives. Moreover, in the case where a UE is ready to cell reselect to a neighbour cell, but the neighbouring cell operates according to an earlier release of the standards and therefore does not support MBS service in the RRC_INACTIVE state (e.g., the neighbouring RAN node operates according to release 17), the UE will need to transition to the RRC_CONNECTED state to maintain the MBS service when it selects the neighbour cell.

One way to control these issues is for the RAN node 5 to configure a UE in the RRC_INACTIVE state with a StateTransitConfig parameter—this parameter defines the RRC state transition thresholds that are used to control the transition between the RRC_INACTIVE state and the RRC_CONNECTED state (and will be detailed below). The StateTransitConfig parameter can be provisioned to UEs in a SIB, over a multicast control channel (e.g. MCCH), or via a paging message. Correspondingly, if the UE is instead in the RRC_CONNECTED state, then the State TransitConfig parameter may be configured by the RAN node 5 and provided via dedicated RRC signalling to the UE. In the case where the UE already received the State TransitConfig parameter in a SIB, over the MCCH or via a paging message (i.e. the UE received the parameter when it was in the RRC_INACTIVE state), then the State TransitConfig parameter provided by the dedicated RRC signalling takes precedence and overwrites the State TransitConfig parameter received when the UE was in the RRC_INACTIVE state.

The thresholds included in the StateTransitConfig parameter may include the following conditions:
RRC CONNECTED to RRC_INACTIVE condition
   RSRP>RSRPConnectedtoInactivethres
   RSRQ>RSRQConnectedtoInactivethres
RRC_INACTIVE to RRC_CONNECTED condition
   RSRP<RSRPInactivetoConnectedthres
   RSRQ<RSRQInactivetoConnectedthres

Where the RSRP is the Reference Signal Received Power and the RSRQ is the Reference Signal Received Quality. These are measurements of the received signals that the UE measures and will be well known to those of ordinary skill in the art.

The StateTransitConfig parameter may be associated with each TMGI such that the requirement to transition between RRC states may be different depending on the MBS service that the UE receives. The StateTransitConfig parameter may be communicated to UEs, for example, in a message carrying a configuration (such as an RRC_INACTIVE-SUPPORTIVE-configuration). The structure of such a message may take the following format:
RRC_INACTIVE-SUPPORTIVE-configuration::=SEQUENCE {
MBSservice TMGI
State TransitConfig
}

Reference will now be made to a further example embodiment for controlling RRC state transition in the context of a split MRB (MBS Radio Bearer). In this regard, it may be beneficial for a UE to transition from the RRC_INACTIVE state to the RRC_CONNECTED state to ensure the reliability of a desired MBS service in the case where the reference signal received power (RSRP)/reference signal received quality (RSRQ) of the point-to-multipoint (PTM) leg does not meet a configured threshold. To facilitate this state transition, the UE can establish an RRC connection to the network and notify the network, with a modified RRCSetupComplete message, which one or more MBS services require a reliability enhancement, e.g. achieved by the network configuring an additional PTP leg in the MRB. The structure of the modified RRCSetupComplete may take the following format:
RRCSetupComplete::=SEQUENCE {
rrc-transition Identifier RRC-transition Identifier,
criticalExtensions CHOICE {
rrcSetupComplete RRCSetupComplete-IEs,
criticalExtensionsFuture SEQUENCE { }
}
}
RRCSetupComplete-IEs::=SEQUENCE {
selectedPLMN-Identity INTEGER (1 . . . maxPLMN),
registeredAMF RegisteredAMF
OPTIONAL,
guami-Type ENUMERATED {native, mapped}
OPTIONAL,
}
OPTIONAL,
}
RRCSetupComplete-v1810-IEs::=SEQUENCE {
MBS-reliability-r18 TMGI-list OPTIONAL, or
MBS-reliability-r18 MRB-id-list OPTIONAL,
}
}

### 3. MBS Session Establishment

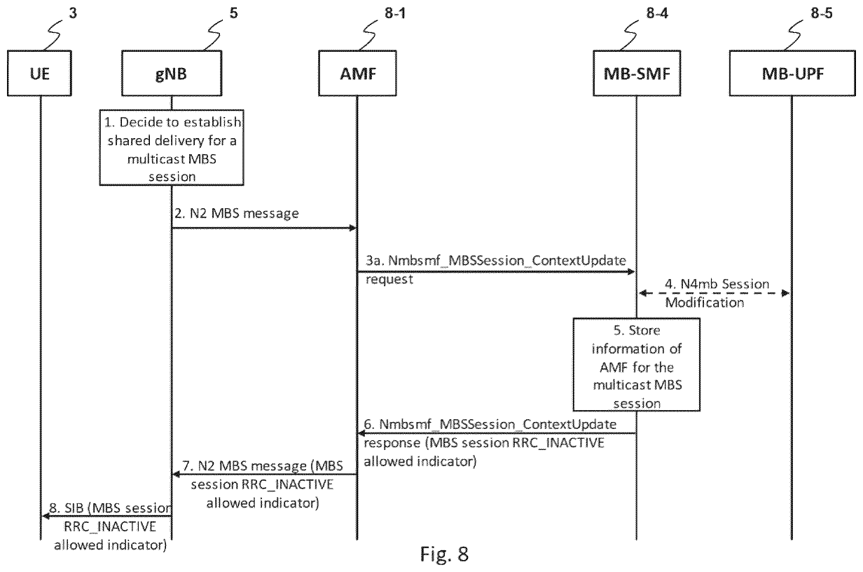

MBS session establishment and associated management procedures are specified in 3GPP TS 23.247. One such procedure specified in clause 7.2.1.4 of this standard relates to the “establishment of shared delivery towards a RAN node” (shared delivery meaning delivery of an MBS service to a UE via multicast transmission). However, the current procedure does not inform a gNB-CU and one or more gNB-DUs whether or not a UE 3 is allowed to operate in the RRC_INACTIVE state for this particular MBS session. Accordingly, a modified “establishment of shared delivery towards a RAN node” signalling diagram which addresses the above-mentioned problem is presented in FIG. 8, and will be discussed below.

In step 1, an NG-RAN node 5 decides to establish shared delivery for a multicast MBS session when it serves at least one UE 3 within the multicast MBS session. For location dependent services, the NG-RAN node 5 needs to establish shared delivery for the location dependent contents of a multicast MBS session if it serves at least one UE assigned to an MBS Session ID and Area Session ID.

Then, in step 2, the NG-RAN sends an N2 MBS Session request message (including one or more of an MBS Session ID, [Area Session ID], N2 SM information ([unicast DL tunnel Info])) towards the AMF 8-1. If the NG-RAN node 5 is configured to use unicast transport for the shared delivery, it allocates a GTP tunnel endpoint and provides the unicast DL tunnel Info in the request, which includes the GTP tunnel endpoint and NG-RAN node 5 address. For location dependent MBS services, the NG-RAN node 5 also provides the Area Session ID.

In step 3, the AMF 8-1 selects the MB-SMF 8-4 serving the multicast MBS session, e.g. using the NRF discovery service or locally stored information. AMF 8-1 invokes an Nmbsmf_MBSSession_ContextUpdate request (including one or more of MBS Session ID, [Area Session ID], N2 SM information) to the MB-SMF 8-4. The AMF 8-1 stores the information of one or more NG-RAN nodes (e.g. NG-RAN node ID) for the subsequent signalling related to the multicast MBS Session.

Step 4 is indicated by dotted lines and is conditional upon the MB-SMF 8-4 receiving unicast DL tunnel Info in step 3. If so, MB-SMF 8-4 configures the MB-UPF 8-5 to send multicast data for the multicast MBS session (or location dependent content of the multicast MBS session if an Area Session ID was received) towards that GTP tunnel endpoint via unicast transport.

Continuing now with reference to step 5, the MB-SMF 8-4 stores the information of the AMF 8-1 (e.g. AMF ID) in the MBS Multicast MBS session context (or location dependent part of the Multicast MBS Session Context if an Area Session ID was received) to enable subsequent signalling towards that AMF 8-1.

The steps above are not changed in relation to the current procedures as outlined in TS 23.247. The following steps 6 to 8 represent modifications and additions to the corresponding steps currently outlined in TS 23.247 to solve the problem identified above. Turning to step 6, the MBS-SMF 8-4 sends a message (which may be referred to as a Nmbsmf_MBSSession_ContextUpdate Response message) comprising an MBS session RRC_INACTIVE allowed indicator and a TMGI, in addition to any other appropriate parameters, to the AMF 8-1. The MBS session RRC_INACTIVE allowed indicator indicates whether or not the TMGI allows UEs to receive the corresponding MBS service in the RRC_INACTIVE state. Moreover, if the MB-SMF 8-4 did not receive unicast DL tunnel Info in step 3, it provides the multicast DL tunnel info that includes transport multicast address (e.g. a Lower Layer Source Specific IP Multicast address (LL SSM)) and a GTP tunnel endpoint for multicast transport of the shared delivery.

Then, in step 7, the AMF 8-1 sends an N2 MBS message comprising the MBS session RRC_INACTIVE allowed indicator and TMGI, along with any additional relevant parameters, to NG-RAN node 5. Finally, in step 8, the NG-RAN gNB provides the MBS session RRC_INACTIVE allowed indicator and the TMGI to the UE 3 via, for example, a system information block (SIB) (or instead over a multicast control channel (MCCH), in a paging message, or in an RRCRelease message). As a consequence of the UE 3 receiving the MBS session RRC_INACTIVE allowed indicator and the associated TMGI, the UE 3 will be able to use MBS services corresponding to this TMGI in the RRC_INACTIVE state, thereby beneficially obviating the need for the UE 3 to transition to the RRC CONNECTED state.

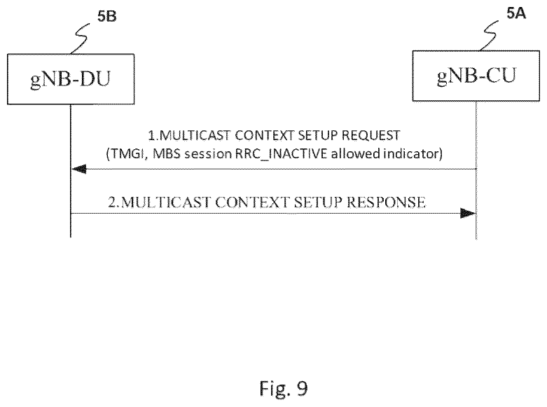

To ensure that the multicast context is setup correctly, the current multicast context setup (defined in TS 38.473 at clause 8.14.6) is modified to include the MBS session RRC_INACTIVE allowed indicator as shown in FIG. 9. As illustrated in step 1 of FIG. 9, the gNB-CU 5A sends a message (sometimes referred to as a MULTICAST CONTEXT SETUP REQUEST) which includes the MBS session RRC_INACTIVE allowed indicator and associated TMGI received in step 7 of FIG. 8 to the gNB-DU 5B. The gNB-DU 5B confirms receipt of the message sent by the gNB-CU 5A by sending a message (sometimes referred to as a MULTICAST CONTEXT SETUP RESPONSE message) to the gNB-CU 5A in step 2. Accordingly, following the above described procedure, the gNB-CU 5A and one or more gNB-DUs 5B both know if the UE is allowed to operate in the RRC_INACTIVE mode for the MBS session, and hence the gNB-CU can configure an appropriate MRB for the UE 3 and RLC entity in the gNB-DU.

### 4. RRC_INACTIVE Mode Mobility

As discussed above according to release 17 of the MBS standards, a UE should transition to the RRC_CONNECTED state to register for an MBS service with the core network. However, according to the more recent release 18, after the registration procedure, the UE is free to transition to the RRC_INACTIVE state (per the conditions noted above in the example embodiment entitled “RRC States Transition”). It should be appreciated that when UEs operating in the RRC_INACTIVE state are in mobility and perform a cell re-selection, the UEs do not need to transition to RRC_CONNECTED mode to effect the cell re-selection. However, if the neighbour cell to which the UE wishes to re-select (and hence camp on) does not have an ongoing PTM MBS session for the UE to receive in the camping cell, then the UE will transition to the RRC CONNECTED state.

According to release 17, since only UEs in the RRC_CONNECTED state are supported for multicast, the multicast configuration is not scheduled in MCCH, but instead in an RRCReconfiguration message, which is only available when the UE is in the RRC CONNECTED state (the RRCReconfiguration message is used for handover and provides all neighbour cell information). Accordingly, a solution which facilities the provision of a multicast configuration for UEs operating in the RRC_INACTIVE mode without the need for an RRC state transition is provided below.

According to this example embodiment, a new channel (Multicast channel, MCCH) is provided for UEs operating in the RRC_INACTIVE state, whereby this channel can provide a multicast configuration for RRC_INACTIVE UEs. It will be appreciated that the new MCCH is scheduled in a system information block (SIB), as RRC_INACTIVE UEs can still receive SIBs, and hence that in the following discussion reference to a SIB-MCCH refers to a UE reading a SIB to obtain the scheduling of the MCCH.

With regard to dealing with mobility of RRC_INACTIVE state UEs, in a first example, a serving cell provides the neighbour cell ongoing MBS Session list in the SIB-MCCH (or the SIB itself). This allows the RRC_INACTIVE UE to see which neighbour cells have the MBS session that the UE is interested in. However, if a UE is interested in an MBS session which is not ongoing in the neighbour cell's supported MBS Session list, then:
the RRC_INACTIVE UE can transition to the RRC_CONNECTED state. Then after handover to the target cell, the UE triggers the MBS joining procedure set out in the MBS joining procedure of clause 7.2.1.3 of 3GPP TS 23.247. However, if there is no ongoing MBS session in the target cell, the network establishes the MBS joining procedure set out in the MBS joining procedure of clause 7.2.1.3 of 3GPP TS 23.247; or alternatively
the UE operating in the RRC_INACTIVE state can prioritise other neighbour cells that support the desired MBS session. If there is not any other cell which supports the MBS session, the UE will perform a regular cell re-selection to a cell which doesn't support the MBS session, and then transition to the RRC CONNECTED state to trigger the MBS joining procedure set out in the MBS joining procedure of clause 7.2.1.3 of 3GPP TS 23.247. The serving cell can send a supported cell/supported frequency list for the desired MBS session to the UE in one of: a paging message, an RRCRelease message, a RRC dedicated message, a SIB message, or in a message over the MCCH.

The base station may inform the UE which MBS service can be received when the UE is in the RRC_INACTIVE state using the following RRC_INACTIVE-SUPPORTIVE-indication message:
RRC_INACTIVE-SUPPORTIVE-indication::=SEQUENCE {
   MBSservice TMGI
   RRCINACTIVESUPPORTIVE RRCINACTIVESUPPORTIVE (true,false)
}

In a second example, the serving cell only broadcasts (in its SIB-MCCH) a list of the neighbour cells/frequencies that have an on-going MBS service. If the UE is looking to reselect a neighbour cell, then the UE can check from the information broadcast by its currently serving cell if the neighbour cell has an on-going MBS service and if it does then the UE reads the neighbour cell's MCCH to obtain the MBS session list supported by the neighbour cell. In this way, the UE can check if the desired MBS session is ongoing in the neighbour cell before deciding to reselect to that neighbour cell.

If the UE re-selects a cell which does not have any ongoing MBS session, the UE will transition to RRC_CONNECTED to trigger the MBS joining procedure described in clause 7.2.1.3 of TS 23.247.

### 5. Handover Optimisation

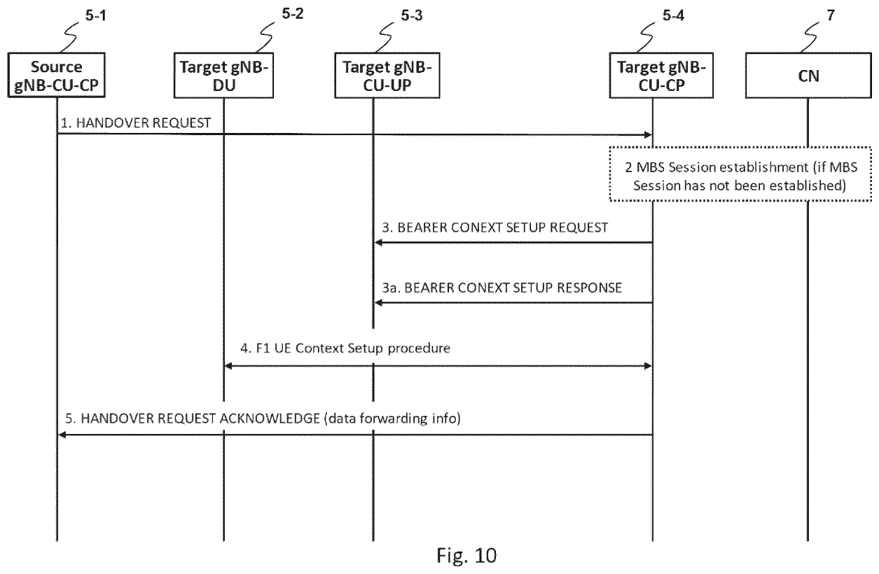

As specified in the current standards (3GPP TS 38.401, at clause 8.9.4), as part of the handover procedure, the source gNB sends a Handover Request message to the target gNB. The Handover Request message has an MBS configuration as part of its RRC context information, i.e. the Handover Request message includes details of MBS sessions for the UE handing over to the target cell. Currently, if there is no ongoing MBS Session in the target gNB, the target gNB should commence an MBS session establishment procedure in the target cell in accordance with clause 7.2.1.3 of 3GPP TS 23.247-however, it will take a long time to establish an MBS session in the target gNB during the handover if there is no ongoing MBS session for the UE performing the handover procedure. A solution to this problem is proposed in the following description with reference to FIG. 10 (FIG. 10 represents an abridged and modified version of the “Inter-gNB handover involving gNB-CU-UP change” signalling diagram of clause 8.9.4 of TS 38.401).

Firstly, with reference to step 1 of FIG. 10, the source gNB-CU-CP 5-1 sends a conditional Handover Request message to the target gNB-CU-CP 5-4. The handover request message includes, as part of the RRC configuration the MBS configuration for the UE that might be the subject of the handover to the target. A conditional handover is a sort of pre-handover, before the handover condition is satisfied.

In step 2, in a case where there is no MBS session in the target gNB, the target gNB-CU-CP 5-4 establishes an MBS Session establishment with the core network-typically with the MB-SMF (e.g. per clause 7.2.1.3 of TS 23.247).

In this way, the target gNB beneficially “pre-establishes” the MBS session if it has not already been established before handover of the UE is actually performed. This procedure is much faster than using the normal handover procedure, where the UE would first have to handover to the target base station before then requesting the MBS service from the target base station which would then seek to establish the MBS session with the core network if it didn't already exist.

Then, in step 3, the gNB-CU-CP 5-4 sends a BEARER CONTEXT SETUP REQUEST message containing UL TNL address information for S1-U or NG-U, and if required, DL TNL address information for X2-U to setup the bearer context in the gNB-CU-UP 5-3. For NG-RAN, the gNB-CU-CP 5-4 decides flow-to-DRB mapping and sends the generated SDAP and PDCP configuration to the gNB-CU-UP 5-3. As this handover is conditional, the BEARER CONTEXT SETUP REQUEST message indicates the included security context is to be ignored and not to initiate sending downlink packets until the UE successfully accesses the target.

In step 3a, the gNB-CU-UP 5-3 responds with a BEARER CONTEXT SETUP RESPONSE message containing the UL TNL address information for F1-U, and DL TNL address information for S1-U or NG-U, and if required, UL TNL address information for X2-U or Xn-U.

Then, in step 4, a F1 UE context setup procedure is performed to setup one or more bearers in the gNB-DU 5-2.

Finally, in step 5, the target gNB-CU-CP 5-4 responds to the source gNB-CU-CP 5-1 with a HANDOVER REQUEST ACKNOWLEDGE message. As this handover procedure is conditional, the target gNB-CU-CP 5-4 ensures that the EARLY STATUS TRANSFER information is forwarded to the right gNB-CU-UP 5-3 (e.g. separate UE-associated signalling connection over Xn interface for each gNB-CU-UP).

### <Modifications and Alternatives >

Detailed example embodiments have been described above. As those skilled in the art will appreciate, a number of modifications and alternatives can be made to the above example embodiments whilst still benefiting from the disclosures embodied therein. By way of illustration only a number of these alternatives and modifications will now be described.

The above description refers to MBS for simplicity. However, MBS functionality may also be referred to as Multimedia Broadcast/Multicast Services (MBMS) functionality or similar.

Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP TS 38.300 V16.7.0 and 3GPP TS 37.340 V16.7.0 define the following nodes, amongst others:
gNB: node providing NR user plane and control plane protocol terminations towards the UE, and connected via the NG interface to the 5G core network (5GC).

ng-eNB: node providing E-UTRA user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

It will be appreciated that the above example embodiments may be applied to 5G New Radio and LTE systems (E-UTRAN), and any future generation systems. A base station that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

In the above description, the UE, the access network node, and the data network node are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware, or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the access network node, and the data network node as a signal over a computer network, or on a recording medium. Further, the functionality performed by part or all of this software may be performed using one or more dedicated hardware circuits. However, the use of software modules is preferred as it facilitates the updating of the UE, the access network node, and the data network node in order to update their functionalities.

The above example embodiments are also applicable to ‘non-mobile’ or generally stationary user equipment.

The receiving of the information may be performed via an MBS Control Channel (MCCH) or via an application layer procedure.

The core network function may include at least one of a function for access and mobility management and a function for session management.

Various other modifications will be apparent to those skilled in the art and will not be described in further detail here.

Although the present disclosure has been described with reference to the exemplary example embodiments, the present disclosure is not limited to the above. Various changes that can be understood by those skilled in the art can be made to the configuration and details of the present disclosure within the scope of the disclosure.

This application is based upon and claims the benefit of priority from UK patent application No. 2211642.0, filed on Aug. 9, 2022, the disclosure of which is incorporated herein in its entirety by reference.

The program can be stored and provided to the computer device using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to the computer device using any type of transitory computer readable media. Examples of transitory computer readable media include electric signals, optical signals, and electromagnetic waves. Transitory computer readable media can provide the program to the computer device via a wired communication line, such as electric wires and optical fibers, or a wireless communication line.

For example, the whole or part of the exemplary example embodiments disclosed above can be described as, but not limited to, the following supplementary notes.

(Supplementary Note 1)

A method for an access network node, the method comprising:
transmitting, to a user equipment, UE, a first message including an enquiry of a capability of the UE to receive a multicast/broadcast service, MBS, in a case where the UE is in a Radio Resource Control, RRC,_INACTIVE state; and
receiving from the UE, a second message including a list of one or more MBS sessions which the UE can support in a case where the UE is in the RRC_INACTIVE state, in a case where the UE has information identifying at least one MBS that is available to the UE.

### (Supplementary Note 2)

The method according to supplementary note 1, wherein the first message is transmitted in a dedicated RRC message, in a paging message, in a system information block, SIB, or over a multicast control channel.

### (Supplementary Note 3)

The method according to supplementary note 1 or 2, wherein the first message is a UE RRC_INACTIVE support enquiry message.

### (Supplementary Note 4)

The method according to supplementary note 3, wherein the second message is a UE RRC_INACTIVE Support report message.

### (Supplementary Note 5)

A method for an access network node, the method comprising:
transmitting, to a user equipment, UE, in a Radio Resource Control, RRC,_INACTIVE state, a paging message including a list of at least one Temporary Mobile Group Identity, TMGI, related to a respective multicast/broadcast service, MBS, session that is available, wherein:
the paging message includes:
a respective indication associated with each TMGI in the list, the respective indication indicating:
   if the UE needs to transition to an RRC_CONNECTED state to receive a respective MBS session related to the each TMGI, or
   if the UE can remain in the RRC_INACTIVE state to receive a respective MBS session related to the each TMGI; or
an indication which configures the UE not to transition to the RRC CONNECTED state in response to receiving the paging message in the case where the UE is a release 18 or later UE.

### (Supplementary Note 6)

The method according to supplementary note 5, wherein the indication is an RRCCONNECTEDINDICATION-R18 indication.

### (Supplementary Note 7)

A method for an access network node, the method comprising:
transmitting, to a user equipment, UE, using a multicast/broadcast service, MBS, having a Temporary Mobile Group Identity, TMGI, a parameter associated with the TMGI wherein the parameter indicates a condition that, if satisfied, causes the UE to transition from a Radio Resource Control, RRC,_CONNECTED state to an RRC_INACTIVE state or to transition from the RRC_INACTIVE state to the RRC_CONNECTED state.

### (Supplementary Note 8)

The method according to supplementary note 7, wherein the parameter is transmitted to the UE in a system information block, SIB, over a multicast channel, in a paging message, or in dedicated RRC signalling.

### (Supplementary Note 9)

The method of supplementary note 7 or 8, wherein the condition includes whether one or more received signal measures are greater or less than a threshold level.

### (Supplementary Note 10)

The method according to supplementary note 9, wherein:
the condition that causes the UE to transition from an RRC_CONNECTED state to an RRC_INACTIVE includes whether a reference signal received power, RSRP, measured by the UE is greater than a first threshold and/or whether a reference signal received quality, RSRQ, measured by the UE is greater than a second threshold; or
the condition that causes the UE to transition from an RRC_CONNECTED state to an RRC_INACTIVE includes whether a reference signal received power, RSRP, measured by the UE is less than a third threshold and/or whether a reference signal received quality, RSRQ, measured by the UE is less than a fourth threshold.

### (Supplementary Note 11)

The method according to any one of supplementary notes 7 to 10, wherein the parameter is a State TransitConfig parameter.

### (Supplementary Note 12)

The method according to any one of supplementary notes 7 to 11, wherein the indication is transmitted as part of an RRC_INACTIVE-SUPPORTIVE-configuration.

### (Supplementary Note 13)

A method for an access network node, the method comprising:
providing a multicast/broadcast service, MBS, to a user equipment, UE via an MBS radio bearer, MRB;
receiving, from the UE, a notification requesting a reliability enhancement for the MBS service; and
provisioning the reliability enhancement.

### (Supplementary Note 14)

The method according to supplementary note 13, wherein the notification is received in an RRCSetupComplete message.

### (Supplementary Note 15)

The method according to supplementary note 13 or 14, wherein the notification includes a list of at least one TMGIs for which reliability enhancement is requested for the MBS service associated with the at least one TMGI in the list, or wherein the notification includes a list of at least one MBS radio bearer, MRB, that is associated with an MBS service that requires reliability enhancement.

### (Supplementary Note 16)

The method according to any one of supplementary notes 13 to 15, wherein the reliability enhancement includes the access network node provisioning an additional point-to-point, PTP, leg in the MRB.

### (Supplementary Note 17)

A method for an access network node having a central unit and a distributed unit, the method comprising:
receiving, by the central unit, from a core network node, an indication of at least one multicast/broadcast service, MBS, session which a user equipment, UE, can access in a case where the UE is in a Radio Resource Control, RRC,_INACTIVE state;
   transmitting, by the central unit, the indication to the distributed unit;
   receiving, by the central unit, a response from the distributed unit;
   and transmitting, by the distributed unit, the indication to the UE.

### (Supplementary Note 18)

The method according to supplementary note 17, wherein the indication includes an RRC_INACTIVE allowed indicator and a Temporary Mobile Group Identity, TMGI, for each of the at least one MBS session.

### (Supplementary Note 19)

A method for a core network node, the method comprising:
transmitting, to a second core network node, a message including an indication of one or more multicast/broadcast service, MBS, sessions which a user equipment, UE, can access in a case where the UE is in an RRC_INACTIVE state.

### (Supplementary Note 20)

The method according to supplementary note 19, wherein the core network node is a Multicast/Broadcast Session Management Function, MB-SMF, and the second core network node is an Access Management Function, AMF.

### (Supplementary Note 21)

The method according to supplementary note 19 or 20, wherein the message is an Nmbsmf_MBSSession_ContextUpdate Response message.

### (Supplementary Note 22)

A method for a core network node, the method comprising:
transmitting, to an access network node, a message including an indication of one or more multicast/broadcast service, MBS, sessions which a user equipment, UE, can access in a case where the UE is in a Radio Resource Control, RRC,_INACTIVE state.

### (Supplementary Note 23)

The method according to supplementary note 22, wherein the core network node is an Access Management Function, AMF.

### (Supplementary Note 24)

The method according to supplementary note 22 or 23, wherein the message is an N2 MBS message.

### (Supplementary Note 25)

A method for a first access network node, the method comprising:
transmitting, to a user equipment, UE, being served by the first access network node, information that includes an ongoing multicast/broadcast service, MBS, session list of a second access network node neighbouring the first access network node or a neighbour cell/frequency list of at least one neighbouring access network node that has at least one on-going MBS session.

### (Supplementary Note 26)

The method according to supplementary note 25, wherein the transmitting transmits the information via a system information block or a multicast control channel.

### (Supplementary Note 27)

The method according to supplementary note 25 or 26, wherein the serving cell sends a supported cell/supported frequency list for the MBS session list to the UE in one of: a paging message, an RRCRelease message, an RRC dedicated message, a SIB message, or in a message over the MCCH.

### (Supplementary Note 28)

A method performed by a source access network node for handover of a user equipment, UE, to a target access network node, the method comprising:
transmitting a conditional handover request message to the target access network node, the conditional handover request message including MBS configuration information for the UE.

### (Supplementary Note 29)

A method performed by a target access network node for handover of a user equipment, UE, from a source access network node, the method comprising:
receiving a conditional handover request message from the source access network node, the conditional handover request message including MBS configuration information for the UE;
in the case where there is no on-going MBS session in the target access network node, establishing an MBS session with a core network.

### (Supplementary Note 30)

The method according to supplementary note 29, wherein the establishing is performed before the UE is handed over to the target access network node.

### (Supplementary Note 31)

The method according to supplementary note 29 or 30, wherein the establishing is performed in response to receiving the conditional handover request.

### (Supplementary Note 32)

A method for a user equipment, UE, the method comprising:
receiving, from an access network node, a first message including an enquiry of a capability of the UE to receive a multicast/broadcast service, MBS, in a case where the UE is in a Radio Resource Control, RRC,_INACTIVE state; and
transmitting, to the access network node, a second message including a list of one or more MBS sessions which the UE can support in a case where the UE is in the RRC_INACTIVE state, based on information identifying at least one MBS that is available to the UE.

### (Supplementary Note 33)

A method for a user equipment, UE, that is in a Radio Resource Control, RRC,_INACTIVE state, the method comprising:
receiving, from an access network node, a paging message including a list of at least one Temporary Mobile Group Identity, TMGI, related to a respective multicast/broadcast service, MBS, session that is available, wherein:
the paging message includes:
   a respective indication associated with each TMGI in the list, the respective indication indicating:
      if the UE needs to transition to an RRC_CONNECTED state to receive the related MBS session, or
      if the UE can remain in the RRC_INACTIVE state to receive the related MBS session; or
   an indication which configures the UE not to transition to the RRC CONNECTED state in response to receiving the paging message, in a case where the UE is a release 18 or later UE.

### (Supplementary Note 34)

A method for a user equipment, UE, the method comprising:
receiving a multicast/broadcast service, MBS, having a Temporary Mobile Group Identity, TMGI;
receiving, from an access network node, a parameter associated with the TMGI wherein the parameter indicates a condition that, when satisfied, causes the UE to transition from a Radio Resource Control, RRC, CONNECTED state to an RRC_INACTIVE state or to transition from the RRC_INACTIVE state to the RRC_CONNECTED state; and
transitioning between the RRC_CONNECTED state and the RRC_INACTIVE state based on the parameter.

### (Supplementary Note 35)

A method for a user equipment, UE, the method comprising:
receiving, from an access network node a multicast/broadcast service, MBS, via an MBS radio bearer, MRB, in a case where the UE is in an RRC_INACTIVE state;

transitioning to an RRC_CONNECTED state in the event that a signal strength of the MRB is below a threshold value; and
transmitting to the access network node, a notification requesting a reliability enhancement for the MBS service.

### (Supplementary Note 36)

A method for a user equipment, UE, the method comprising:
receiving, from a distributed unit of an access network node, an indication of one or more multicast/broadcast service, MBS, sessions which a user equipment, UE, can access in a case where the UE is in an RRC_INACTIVE state.

### (Supplementary Note 37)

A method for a user equipment, UE, the method comprising:
receiving, from a first access network node, information that includes an ongoing multicast/broadcast service, MBS, session list of a second access network node neighbouring the first access network node, or that includes a neighbour cell/frequency list of at least one neighbouring access network node that has at least one on-going MBS session.

### (Supplementary Note 38)

An access network node comprising:
means for transmitting, to a user equipment, UE, a first message including an enquiry of a capability of the UE to receive a multicast/broadcast service, MBS, in a case where the UE is in a Radio Resource Control, RRC,_INACTIVE state; and
means for receiving from the UE, a second message including a list of one or more MBS sessions which the UE can support in a case where the UE is in the RRC_INACTIVE state, in a case where the UE has information identifying at least one MBS that is available to the UE.

### (Supplementary Note 39)

An access network node comprising:
means for transmitting, to a user equipment, UE, in a Radio Resource

Control, RRC,_INACTIVE state, a paging message including a list of at least one Temporary Mobile Group Identity, TMGI, related to a respective multicast/broadcast service, MBS, session that is available, wherein:
the paging message includes:
   a respective indication associated with each TMGI in the list, the respective indication indicating:
      if the UE needs to transition to an RRC_CONNECTED state to receive a respective MBS session related to the each TMGI, or
      if the UE can remain in the RRC_INACTIVE state to receive a respective MBS session related to the each TMGI; or
   an indication which configures the UE not to transition to the RRC CONNECTED state in response to receiving the paging message in the case where the UE is a release 18 or later UE.

### (Supplementary Note 40)

An access network node comprising:
means for transmitting, to a User Equipment, UE, using a multicast/broadcast service, MBS, having a Temporary Mobile Group Identity, TMGI, a parameter associated with the TMGI wherein the parameter indicates a condition that, if satisfied, causes the UE to transition from a Radio Resource Control, RRC, CONNECTED state to an RRC_INACTIVE state or to transition from the RRC_INACTIVE state to the RRC_CONNECTED state.

### (Supplementary Note 41)

An access network node comprising:
means for providing a multicast/broadcast service, MBS, to a User Equipment, UE via an MBS radio bearer, MRB;
means for receiving, from the UE, a notification requesting a reliability enhancement for the MBS service; and means for provisioning the reliability enhancement.

### (Supplementary Note 42)

An access network node having a central unit and a distributed unit, wherein
the central unit comprises:
means for receiving, from a core network node, an indication of at least one multicast/broadcast service, MBS, session which a user equipment, UE, can access in a case where the UE is in a Radio Resource Control, RRC,_INACTIVE state;
   means for transmitting the indication to the distributed unit; and
   means for receiving a response from the distributed unit; and
the distributed unit comprises:
means for transmitting the indication to the UE.

### (Supplementary Note 43)

A core network node comprising:
means for transmitting, to an access network node, a message including an indication of one or more multicast/broadcast service, MBS, sessions which a user equipment, UE, can access in a case where the UE is in a Radio Resource Control, RRC,_INACTIVE state.

### (Supplementary Note 44)

A first access network node comprising:
means for transmitting, to a user equipment, UE, being served by the first access network node information that includes an ongoing multicast/broadcast service, MBS, session list of a second access network node neighbouring the first access network node or that includes a neighbour cell/frequency list of at least one neighbouring access network node that has at least one on-going MBS session.

### (Supplementary Note 45)

A source access network node for handover of a user equipment, UE, to a target access network node, the source access network node comprising:
means for transmitting a conditional handover request message to the target access network node, the conditional handover request message including MBS configuration information for the UE.

### (Supplementary Note 46)

A target access network node for handover of a user equipment, UE, from a source access network node, the target access network node comprising:
means for receiving a conditional handover request message from the source access network node, the conditional handover request message including MBS configuration information for the UE;
in the case where there is no on-going MBS session in the target access network node, establishing an MBS session with a core network.

### (Supplementary Note 47)

A user equipment, UE, comprising:
means for receiving, from an access network node, a first message including an enquiry of a capability of the UE to receive a multicast/broadcast service, MBS, in a case where the UE is in a Radio Resource Control, RRC,_INACTIVE state; and
means for transmitting, to the access network node, a second message including a list of one or more MBS sessions which the UE can support in a case where the UE is in the RRC_INACTIVE state, based on information identifying at least one MBS that is available to the UE.

### (Supplementary Note 48)

A user equipment, UE, comprising:
means for receiving, from an access network node and in a case where the UE is in a Radio Resource Control, RRC,_INACTIVE state, a paging message including a list of at least one Temporary Mobile Group Identity, TMGI, related to a respective multicast/broadcast service, MBS, session that is available, wherein:
the paging message includes:
   a respective indication associated with each TMGI in the list, the respective indication indicating:
      if the UE needs to transition to an RRC CONNECTED state to receive the related MBS session, or
      if the UE can remain in the RRC_INACTIVE state to receive the related MBS session; or
   an indication which configures the UE not to transition to the RRC CONNECTED state in response to receiving the paging message, in a case
where the UE is a release 18 or later UE.

### (Supplementary Note 49)

A user equipment, UE, comprising:
means for receiving a multicast/broadcast service, MBS, having a Temporary Mobile Group Identity, TMGI;
means for receiving, from an access network node, a parameter associated with the TMGI wherein the parameter indicates a condition that, when satisfied, causes the UE to transition from a Radio Resource Control, RRC, CONNECTED state to an RRC_INACTIVE state or to transition from the RRC_INACTIVE state to the RRC CONNECTED state; and
means for transitioning between the RRC_CONNECTED state and the RRC_INACTIVE state based on the parameter.

### (Supplementary Note 50)

A user equipment, UE, comprising:
means for receiving, from an access network node a multicast/broadcast service, MBS, via an MBS radio bearer, MRB, in a case where the UE is in an RRC_INACTIVE state;
means for transitioning to an RRC_CONNECTED state in the event that a signal strength of the MRB is below a threshold value; and
means for transmitting to the access network node, a notification requesting a reliability enhancement for the MBS service.

### (Supplementary Note 51)

A user equipment, UE, comprising:
means for receiving, from a distributed unit of an access network node, an indication of one or more multicast/broadcast service, MBS, sessions which a user equipment, UE, can access in a case where the UE is in an RRC_INACTIVE state.

### (Supplementary Note 52)

A user equipment, UE, comprising:
means for receiving, from a first access network node, information that includes an ongoing multicast/broadcast service, MBS, session list of a second access network node neighbouring the first access network node, or that includes a neighbour cell/frequency list of at least one neighbouring access network node that has at least one on-going MBS session.

### REFERENCE SIGNS LIST

1 telecommunication network, telecommunications system
3 UEs
5 NG-RAN, base station
7 core networks
8-1 AMF
8-2 SMF
8-3 UPF
8-4 MB-SMF
8-5 MB-UPF
8-6 MBSF
8-7 MBSTF
8-8 NEF
8-9 AF
8-10 PCF
8-11 NRF
8-12 UDM
8-13 AUSF
8-14 DN

What is claimed is:

1-43. (canceled)

44. A method for an access network node, the method comprising:
transmitting, to a user equipment (UE) in a Radio Resource Control (RRC)_INACTIVE state, a paging message including at least one combination of:
a Temporary Mobile Group Identity (TMGI), and
information indicating whether the UE can stay in the RRC_INACTIVE state to receive a multicast/broadcast service (MBS) corresponding to one or more MBS sessions related to the TMGI, wherein
at least one MBS corresponding to the one or more MBS sessions is provided to the UE while the UE in the RRC_INACTIVE state.

45. The method according to claim 44, wherein
in a case where the at least one combination includes the information indicates that the UE can stay in the RRC_INACTIVE state when the UE receives at least one MBS corresponding to the one or more MBS sessions related to the TMGI, the UE stays in the RRC_INACTIVE state.

46. The method according to claim 44, further comprising:
in a case where at least one of the at least one combination includes the information indicates that the UE is not allowed to stay in the RRC_INACTIVE state when the UE receives at least one MBS corresponding to the one or more MBS sessions related to the TMGI, receiving, from the UE, a RRC resume request message to move the UE to a RRC_CONNECTED state.

47. The method according to claim 44, further comprising:
transmitting, to the UE, information indicating at least one reference signal received power threshold and/or at least one reference signal received quality threshold for causing the UE to move from a RRC_CONNECTED state to the RRC_INACTIVE state or to move from the RRC_INACTIVE state to the RRC_CONNECTED state.

48. The method according to claim 44, further comprising:
transmitting, to the UE, a RRC release message including information including an ongoing MBS session list of the access network node or a neighbour cell/frequency list of at least one neighbouring access network node that has at least one on-going MBS session.

49. The method according to claim 44, further comprising:
transmitting, to another access network node, a conditional handover request message including MBS configuration information for the UE corresponding to an ongoing MBS session, wherein
in a case where the another access network node does not provide MBS corresponding to the ongoing MBS session, a procedure for establishing, between the another access network node and a core network, at least one MBS session for the MBS is initiated.

50. A method for a user equipment (UE) in a Radio Resource Control (RRC)_INACTIVE state, the method comprising:
receiving, from an access network node, a paging message including at least one combination of:
a Temporary Mobile Group Identity (TMGI), and
information indicating whether the UE can stay in the RRC_INACTIVE state to receive a multicast/broadcast service (MBS) corresponding to one or more MBS sessions related to the TMGI; and
receiving at least one MBS corresponding to the one or more MBS sessions while the UE in the RRC_INACTIVE state.

51. The method according to claim 50, further comprising:
in a case where the at least one combination includes the information that the UE can stay in the RRC_INACTIVE state when the UE receives at least one MBS corresponding to the one or more MBS sessions related to the TMGI, staying in the RRC_INACTIVE state.

52. The method according to claim 50, further comprising:
in a case where at least one of the at least one combination includes the information indicates that the UE is not allowed to stay in the RRC_INACTIVE state when the UE receives at least one MBS corresponding to the one or more MBS sessions related to the TMGI, transmitting, to the access network node, a RRC resume request message to move the UE to a RRC_CONNECTED state.

53. The method according to claim 50, further comprising:
receiving, from the access network node, information indicating at least one reference signal received power threshold and/or at least one reference signal received quality threshold for causing the UE to move from a RRC_CONNECTED state to the RRC_INACTIVE state or to move from the RRC_INACTIVE state to the RRC_CONNECTED state.

54. The method according to claim 50, further comprising:
receiving, from the access network node, a RRC release message including information including an ongoing MBS session list of the access network node, or a neighbour cell/frequency list of at least one neighbouring access network node that has at least one on-going MBS session.

55. An access network node comprising:
at least one memory storing instructions; and
at least one processor configured to process the instructions to:
transmit, to a user equipment (UE) in a Radio Resource Control (RRC)_INACTIVE state, a paging message at least one combination of:
a Temporary Mobile Group Identity (TMGI), and
information indicating whether the UE can stay in the RRC_INACTIVE state to receive a multicast/broadcast service (MBS) corresponding to one or more MBS sessions related to the TMGI, wherein
at least one MBS corresponding to the one or more MBS sessions is provided to the UE while the UE in the RRC_INACTIVE state.

56. A user equipment (UE) in a Radio Resource Control (RRC)_INACTIVE state, comprising:
at least one memory storing instructions; and
at least one processor configured to process the instructions to:
receive, from an access network node, a paging message including at least one combination of:
a Temporary Mobile Group Identity (TMGI), and
information indicating whether the UE can stay in the RRC_INACTIVE state to receive a multicast/broadcast service (MBS) corresponding to one or more MBS sessions related to the TMGI; and
receive at least one MBS corresponding to the one or more MBS sessions while the UE in the RRC_INACTIVE state.
